(19) United States
(12) Patent Application Publication
(10) Pub. No.: US 2009/0068475 A1
(43) Pub. Date: Mar. 12, 2009

(54) Self-Adhesive Addition-Crosslinking Silicon Rubber Blends, A Method For The Production Thereof, Methods For Producing Composite Moulded Parts And The Use Thereof

(75) Inventor: Stephan Bosshammer, Leverkusen (DE)

Correspondence Address: RANKIN, HILL & CLARK LLP, 925 EUCLID AVENUE, SUITE 700, CLEVELAND, OH, 44115-1405, US

(73) Assignee: MOMENTIVE PERFORMANCE MATERIALS GMBH, Leverkusen (DE)

(21) Appl. No.: 11/908,854

(22) PCT Filed: Mar. 24, 2006
(86) PCT No.: PCT/EP2006/002739

§ 371 Date: Apr. 30, 2008

(30) Foreign Application Priority Data
Mar. 24, 2005 (DE) 102005014289.3

(51) Int. Cl. B32B 27/00; C08L 83/04; C08G 77/12; B05D 3/02

(52) U.S. Cl. 428/447; 525/100; 427/387; 528/31

(57) ABSTRACT

The invention relates to self-adhesive addition cross linking silicon-rubber blends to a method for the production thereof and to a method for producing composite moulded parts and by means of the inventive blends.

The present invention relates to addition-crosslinking silicone rubber blends, to a method of producing them, to methods of producing composite moldings, and to their use.

The self-adhesive addition-crosslinking silicone rubber blends of the invention feature effective adhesion to substrates without an accompanying need for special treatment of the molds used to produce the moldings, allowing detachment of the addition-crosslinking silicone rubber blends from the mold. Moreover, there is generally no need for subsequent heating of the composite moldings.

A range of methods have been proposed for achieving an adhesive bond between addition-crosslinking silicone elastomers and various substrates. One way is to use what is called a primer, which is employed for the pretreatment of the substrate surface. In processing, this necessitates an additional workstep and also operation with solvents. Both are disadvantageous. Another way is to achieve adhesion of addition-crosslinking silicone elastomers to substrates by adding one or more additives to the noncrosslinked silicone rubber blend.

Another version is the production of a thermoplastic/siloxane blend, where different siloxanes have been mixed into the thermoplastic matrix prior to shaping, and the surface of moldings made from this thermoplastic blend are adhered using an addition-crosslinking silicone rubber. In this context, U.S. Pat. No. 5,366,806 claims hydrogensiloxanes with additional alkenyl group in the thermoplastic matrix, which are bonded with addition-crosslinking polyorganosiloxane rubbers which can preferably contain further organofunctional SiH adhesion promoters.

U.S. Pat. No. 5,366,805 discloses a polycarbonate which contains hydrogensiloxane-containing siloxane copolymers or terpolymers with epoxy or aryl groups. Instead of a siloxane-containing thermoplastic, U.S. Pat. No. 5,418,065 proposes a polypropylene terpolymer which contains addition-crosslinking polyorganosiloxane rubber and epoxy-containing SiH siloxanes, which is adhered in the course of crosslinking. Adhesion takes place, for example, in 8 min at 120° C. In that case the thermoplastic part is injected immediately prior to the application of the silicone rubber. The system allows the composite part to be demolded from a metal mold.

Another solution is the provision of addition-crosslinking polyorganosiloxane rubbers which depending on the nature of the thermoplastic substrate comprise one or more additives and which, under different conditions, can be adhered to said thermoplastic in the course of crosslinking. In this context it is desirable in particular to adhere thermoplastics with high softening temperatures to silicone rubber and conversely to minimize the adhesion to the metallic mold material, i.e., generally steel.

According to U.S. Pat. No. 4,087,585 effective adhesion to aluminum is brought about, for example, by the addition of two additives, a short-chain polysiloxane having at least one SiOH group, and a silane having at least one epoxy group and an Si-bonded alkoxy group. In accordance with J. Adhesion Sci. Technol. Vol. 3, No. 6 pp. 463-473 (1989) effective adhesion to various metals and plastics is achieved by adding an epoxysilane in combination with a homopolymeric crosslinker. EP-A 875 536 achieves improved adhesion to various plastics through the use of an alkoxysilane having an epoxy group and also of a hydrogensilane having at least 20 SiH functions per molecule, these blends also featuring an improved reactivity.

EP 350 951 describes the use of a combination of acryl- or methacryloyloxysilane with an epoxy-functional silane and with a partial allyl ether of a polyhydric alcohol as additives for obtaining permanent adhesion of addition-crosslinking silicone elastomers to glass and metal.

These blends have the disadvantage that they also exhibit effective adhesion to metals and are therefore problematic in the case of processing with uncoated metallic molds.

EP-A2-1085053 discloses how, by adding a combination of glycidyloxypropyltrimethoxysilane and methacryloyloxypropyltrimethoxysilane, effective adhesion to polyamide and polybutylene terephthalate is achieved by subsequent heating of the composite parts, in tandem with ease of demolding from uncoated steel molds. However, a relatively high amount of the silanes is used, and for achieving effective ultimate adhesion it is generally recommended that the composite moldings be subsequently heated, which entails an additional workstep.

U.S. Pat. No. 4,082,726 discloses the use of a terpolymer, i.e., of a siloxane which is composed of at least 3 different siloxy groups. Besides Si-epoxy groups this terpolymer may comprise units including Si-phenyl, SiH, and other siloxy units. In addition to almost any alkenylsiloxanes A) and also a hydrogensiloxane B), this epoxy siloxane is used in order to produce adhesion between a thermoplastic substrate and an addition-crosslinking polyorganosiloxane rubber. No preferred concentrations were disclosed for the organofunctional units on the silicon. The presence of the epoxy-containing terpolymer brings about not only adhesion to thermoplastics but also to metals.

U.S. Pat. No. 5,405,896 discloses, instead of the epoxy-containing siloxane terpolymer, a copolymer or terpolymer containing at least one oxygen-containing phenylene group and also at least one SiH group. The silicone rubbers are cured with adhesion to the thermoplastic surface for 8 min at 120° C., for example. Demolding is successful from an uncoated metal mold.

U.S. Pat. No. 6,127,503 proposes, instead of the oxygen-containing siloxane copolymer or terpolymer, a terpolymer having at least one phenyl or phenylene unit, a nitrogen-containing unit, and an SiH group. The silicone rubbers are cured, with adhesion to the thermoplastic surface, for 10 min at 120° C., for example.

EP 686 671 (U.S. Pat. No. 5,536,803) describes the use as an additive of an organohydrogenpolysiloxane, at least 12 mol % of the monovalent Si-bonded organic radicals being aromatic groups. In this case, although adhesion was found to ABS, but was not quantified, and easy demolding from metallic surfaces was found, the typical technical thermoplastics such as polyamide, polybutylene terephthalate or polyphenylene sulfide, for example, were not evaluated. A specific set problem for these thermoplastics was not seen. Nor was any preferred range disclosed for the SiH content of the corresponding siloxane components. The silicone rubbers were adhered to the thermoplastic surface during crosslinking, for example for 100 sec to 8 min at 60-100° C. The SiH content is stated generally as being more than 2 hydrogen atoms per molecule. In the specific examples a hydrogen content of 6 hydrogensiloxy units per molecule is not exceeded.

EP-A2-1106662 discloses self-adhesive addition-crosslinking silicone elastomer compositions which use polyorganohydrogensiloxanes that have on average less than 20 SiH groups in the molecule. The use of polyorganohydrogensiloxanes of this kind with less than 20 SiH groups in the molecule is described as being essential, since the storage stability of addition-crosslinking silicone rubber blends is affected considerably, i.e., the fluidity is massively adversely affected.

EP-B1-1375622 likewise discloses addition-crosslinking silicone elastomer compositions, which comprise polyorganohydrogensiloxanes and also a specific adhesion promoter based on biphenyl compounds. The use of such biphenyl compounds is disadvantageous, however, on account of their relatively high price.

WO 03/066736 has likewise disclosed addition-crosslinking silicone elastomer compositions which comprise relatively SiH-rich; phenyl-free organohydrogenpolysiloxanes and also phenyl-containing organohydrogenpolysiloxanes. The phenyl-containing organohydrogenpolysiloxanes used are relatively low in SiH.

The inventors of the present patent application found surprisingly that self-adhesive addition-crosslinking silicone elastomer compositions having an SiH content of more than on average 20 SiH groups per molecule, with a comparatively low aromatic groups content, are stable on storage, adhere better to a multiplicity of substrates, ensure a high crosslinking rate, and yet are demoldable from the injection moldings filled with them.

It is an object of the present invention to provide addition-crosslinking silicone rubber blends featuring effective adhesion to a variety of substrates, more particularly to technical thermoplastics with a high softening temperature such as polyamide, polybutylene terephthalate or polyphenylene sulfide, without the need for the molds to be coated to prevent mold sticking or treated with mold release agents, and without the need in general for the composite parts to undergo subsequent heating, for the purpose of processing on an automatic injection molding unit. For this purpose, a search is made for readily and inexpensively producible additive components for silicone rubbers, which can be added separately, also as a separate component, to commercially known, preferably 2-component rubbers.

The invention accordingly provides addition-crosslinking silicone rubber blends comprising:

a) at least one linear or branched organopolysiloxane having at least two alkenyl groups, with a viscosity of 0.01 to 30 000 Pa·s (25° C.),
b1) at least one organohydrogensiloxane having in each case on average at least 20 SiH units per molecule and having at least one organic radical containing at least one constituent selected from aromatic groups, halogen atoms, pseudohalogen groups, polyether groups, aminoalkyl groups, and ammonioalkyl groups,
b2) if desired, one or more organohydrogenpolysiloxanes which have on average at least two SiH groups per molecule and in which the organic radicals are selected from the following: saturated and unsaturated aliphatic hydrocarbon radicals,
c) at least one hydrosilylation catalyst,
d) at least one constituent selected from the group consisting of the following: alkoxysilanes and/or alkoxysiloxanes each having at least one epoxy group, acryl- and methacryloyloxyalkyltrialkoxysilanes, and condensation products of the aforementioned compounds through reaction with water, alcohols, silanols and/or siloxanediols,
e) if desired, at least one inhibitor,
f) if desired, at least one filler with or without surface modification,
g) if desired, at least one auxiliary.

The addition-crosslinking silicone rubber blends of the invention preferably have the following composition (parts are by weight):

100 parts of polyorganosiloxane(s) a)
0.2-60 parts of organohydrogensiloxane(s) b)
1-1000 ppm, based on the metal content of the catalyst c) and total amount of the silicone rubber blend
0.01-10 parts of the epoxyalkoxysilane and/or epoxyalkoxysiloxane d)
0-2 parts of the inhibitor e)
0-300 parts of the filler f) with or without surface modification
0-15 parts of the auxiliaries g).

The addition-crosslinking silicone rubber blend of the invention comprises a) at least one linear or branched organopolysiloxane having at least two alkenyl groups with a viscosity of 0.01 to 30 000 Pa·s (25° C.).

The organopolysiloxane a) can be a branched polysiloxane. The term “branched polysiloxane” also includes macrocyclic and spirocyclic structures, i.e., these are solids melting below 90° C. with melt viscosities in the stated viscosity range, or solids which are soluble in typical solvents or siloxane polymers.

Component a) has essentially no Si—H groups.

The organopolysiloxane a) is preferably a linear or branched polysiloxane which can have the following siloxy units:

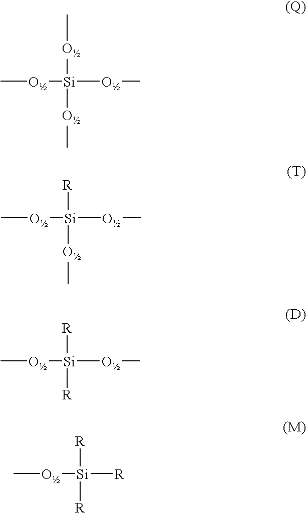

in which the substituents R can be identical or different and are selected from the group consisting of
a linear, branched or cyclic alkyl radical having up to 12 carbon atoms, which if desired can be substituted by at least one substituent selected from the group consisting of phenyl and halogen, more particularly fluorine,
a linear, branched or cyclic alkenyl radical having up to 12 carbon atoms,
a phenyl radical,
hydroxyl, and
a linear, branched or cyclic alkoxy radical having up to 6 carbon atoms,
   or two substituents R from different siloxy units together form a linear, branched or cyclic alkanediyl radical having 2 to 12 carbon atoms between two silicon atoms,
   with the proviso that at least two substituents R per molecule represent the stated alkenyl radical, which can be identical or different.

The stated siloxy units can be randomly distributed or arranged in blocks among one another.

One preferred linear, branched or cyclic alkyl radical having up to 12 carbon atoms is methyl.

One preferred, phenyl-substituted alkyl radical includes, for example, styryl (phenylethyl).

One preferred, halogen-substituted alkyl radical includes, for example, a fluoroalkyl radical with at least one fluorine atom, such as perfluoroalkylethyl radicals, such as preferably 3,3,3-trifluoropropyl or perfluoroalkyl ethers or epoxyperfluoroalkyl ethers, for example.

Linear or branched alkenyl radicals having 2 to 8 carbon atoms include, for example, the following: vinyl, allyl, hexenyl, octenyl, vinylphenylethyl, cyclohexenylethyl, ethylidenenorbornyl or norbornenylethyl or limonyl. Vinyl is particularly preferred.

One preferred linear, branched or cyclic alkoxy radical having up to 6 carbon atoms is, for example, methoxy and ethoxy.

Preferred radicals R are therefore methyl, phenyl, vinyl, and 3,3,3-trifluoropropyl.

Examples of preferred siloxy units are alkenyl units, such as dimethylvinylsiloxy, methylvinylsiloxy, and vinylsiloxy units, alkyl units, such as trimethylsiloxy, dimethylsiloxy, and methylsiloxy units, phenylsiloxy units, such as triphenylsiloxy, dimethylphenylsiloxy, diphenylsiloxy, phenylmethylsiloxy, and phenylsiloxy units, and phenyl-substituted alkylsiloxy units, such as (methyl)(styryl)siloxy.

The number of siloxy units in the organopolysiloxane a) is preferably from 100 to 10 000, with particular preference 300 to 1000.

The alkenyl content of the organopolysiloxane a) is situated preferably in the range from 0.003 mmol/g to 11.6 mmol/g, based on the vinyl-substituted polydimethylsiloxanes, which is transferred correspondingly, equimolarly, to other radicals R having different formula weights.

The organopolysiloxane a) has a viscosity of 0.001 to 30 kPa·s, with very particular preference 5 to 200 Pa·s. The viscosity is determined in accordance with DIN 53 019 at 25° C.

In one preferred embodiment of the invention the organopolysiloxane a) comprises a mixture of different organopolysiloxanes having different alkenyl (preferably vinyl) contents, their alkenyl or vinyl contents preferably differing at least by a factor of 1.5-3.

A preferred mixture of the organopolysiloxanes a) is a blend which comprises an alkenyl-rich (preferably vinyl-rich) organopolysiloxane and at least one, preferably at least two, with particular preference two low-alkenyl (preferably low-vinyl) organopolysiloxanes.

The alkenyl-rich (preferably vinyl-rich) organopolysiloxane preferably has an alkenyl group content of more than 0.4 mmol/g to 11.6 mmol/g in respect of the vinyl-substituted polydimethylsiloxanes, which can be adapted correspondingly, eqimolarly, to other radicals R.

These siloxane polymers may preferably represent branched polysiloxanes as defined above, i.e., solids melting below 90° C. or solids which are soluble in typical solvents or siloxane polymers.

The low-alkenyl (preferably low-vinyl) organopolysiloxane preferably has an alkenyl group content of less than 0.4 mmol/g, preferably 0.02 to 0.4 mmol/g.

The alkenyl content is determined here by way of ¹H-NMR; see A. L. Smith (ed.): The Analytical Chemistry of Silicones, J. Wiley & Sons 1991 Vol. 112 p. 356 ff. in Chemical Analysis ed. by J. D. Winefordner.

The alkenyl group content is preferably set by means of alkenyldimethylsiloxy units. As a result, in addition to the different alkenyl contents, a different chain length is produced, and hence a different viscosity.

Through the use of the above-described mixtures with different alkenyl (preferably vinyl) contents it is possible to optimize the mechanical properties, such as elongation and tear propagation resistance, of the crosslinked silicone rubbers of the invention.

The mixing proportion of the alkenyl-rich organopolysiloxanes a) is preferably 0.5% to 30% by weight, based on the total amount of the organopolysiloxanes a). The total alkenyl content of a mixture of different organopolysiloxanes with different alkenyl (preferably vinyl) contents ought preferably to be less than 0.9 mmol/g.

The organopolysiloxanes a) can be prepared by methods known per se, such as, for example, using alkaline or acidic catalysts, as in U.S. Pat. No. 5,536,803 column 4.

The amount of the organopolysiloxanes a) can be preferably between about 20.5% and 99.8% by weight, based on the total amount of the silicone rubber blend.

The alkenyl-rich organopolysiloxanes include, in particular, solvent-soluble solid resins or liquid resins which are composed preferably of trialkylsiloxy (M units) and silicate units (Q units), and which preferably contain vinyldimethylsiloxy units in an amount such as to result in a vinyl group content of at least 2 mmol/g. These resins may additionally have up to a maximum of 10 mol % of alkoxy or OH groups on the Si atoms.

Component b1) of the addition-crosslinking silicone rubber blend of the invention is at least one organohydrogensiloxane having in each case on average at least 20 SiH units per molecule. If the organohydrogensiloxanes have less than 20 SiH units per molecule, the adhesion to substrates, such as more particularly thermoplastics, is reduced. The organohydrogensiloxanes b1) used in accordance with the invention contain preferably on average at least 23 SiH groups in the molecule, more preferably at least 30 SiH groups in the molecule.

Additionally the organohydrogensiloxane b1) has at least one organic radical which includes at least one constituent selected from aromatic groups, halogen atoms, pseudohalogen groups, polyether groups, aminoalkyl groups, and ammonioalkyl groups. The organohydrogensiloxane b1) preferably includes at least one organic radical which contains on average at least one aromatic group.

The organohydrogensiloxane b1) is selected preferably from linear, branched or cyclic polysiloxanes which can have the following siloxy units:

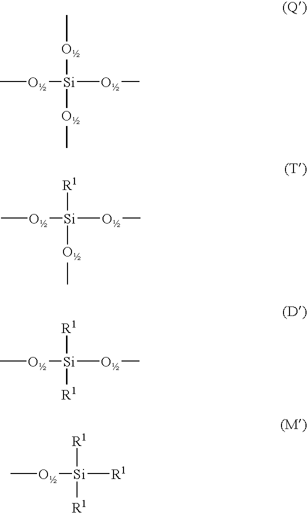

in which R¹ can be identical or different and is selected from the group
consisting of
   hydrogen
   a linear, branched or cyclic alkyl radical having up to 12 carbon atoms, which if desired can be substituted by at least one substituent selected from the group consisting of phenyl, naphthyl, biphenyl, biphenyl ether and halogen, more particularly fluorine,
   a linear, branched or cyclic alkenyl radical having up to 12 carbon atoms,
   an aromatic group, and
   a linear, branched or cyclic alkoxy radical having up to 6 carbon atoms,
      or two groups R¹ from different siloxy units together form a linear, branched or cyclic alkanediyl radical having 2 to 12 carbon atoms between two silicon atoms.

In a first embodiment the Si—H content of the organohydrogensiloxane b1), defined as the proportion of the silicon-bonded H atoms relative to the sum of the silicon-bonded H atoms and of the silicon-bonded organic groups, is more than 36 mol %.

Particular preference is given to an organohydrogensiloxane b1) which has at least one unsubstituted or substituted aromatic group, with particular preference a phenyl, naphthyl, biphenyl or biphenyl ether group. Preferred aromatic units as substituent R1 include, for example, the following: aromatic units in which the aromatic group is attached directly to a silicon atom, such as phenyl, C1-C10-alkylphenyl, C2-C10-alkylenephenyl, C1-C10-alkoxyphenyl, C2-C10-alkyleneoxyphenyl, halophenyl, and naphthyl, and aromatic units in which the aromatic group is attached via an alkyl group to the silicon atom, such as phenyl(C1-C12)-alkyl. Preference is given to aromatic groups, more particularly phenyl, which is attached directly to a silicon atom.

The amount of organic radicals containing aromatic groups in the organohydrogenpolysiloxane b1), based on the amount of all radicals on the silicon atoms (with the exception of the Si—O—Si oxygen atoms), in other words including hydrogen atoms and the organic radicals, is preferably less than 12 mol %, preferably less than 8 mol %, more preferably less than 7.4 mol %. The minimum amount of aromatic groups is preferably 0.5 mol %, more preferably 1 mol %.

The preferred organohydrogensiloxane b1) is a linear triorganosiloxy- and/or diorganohydrogensiloxy-endstopped organohydrogensiloxane, wherein the triorganosiloxy end groups are selected from the group consisting of trimethylsiloxy, triphenylsiloxy, diphenylmethylsiloxy, phenyldimethylsiloxy, phenylethyldimethylsiloxy, and phenylpropyldimethoxysiloxy, the diorganohydrogensiloxy end group is preferably a dimethylhydrogensiloxy group, and that has on average 20 to 1000 methylhydrogensiloxy units, on average 0 to 500 dimethylsiloxy groups, on average less than 360 (methyl)(phenyl)siloxy units, and/or on average less than 180 diphenylsiloxy units, preferably less than 111 or 222.

The molar ratio of dimethylsiloxy to methyl-hydrogen-siloxy units is preferably less than 0.1

The organohydrogensiloxane b1) preferably has a content of more than 2 mmol SiH/g up to about 16 mmol SiH/g. With particular preference the organohydrogensiloxane b1) has a content of more than 7 mmol SiH/g

based on polymethylhydrogendimethylsiloxanes, which is to be adapted correspondingly, equimolarly, in the presence of radicals R1 having a different formula weight.

The viscosity of the organohydrogensiloxanes b1) is, for example, 10 mPa·s to 100 Pa·s, preferably 15 mPa·s to 10 Pa·s (25° C.).

The SiH content is determined here by way of ¹H-NMR; see A. L. Smith (ed.): The Analytical Chemistry of Silicones, J. Wiley & Sons 1991 Vol. 112 p. 356 ff. in Chemical Analysis ed. by J. D. Winefordner. The Si-phenyl content is likewise determined by 1H-NMR and/or 29Si-NMR; see A. L. Smith (ed.); loc. cit.

The addition-crosslinking silicone rubber blend of the invention further comprises, if desired, one or more organohydrogensiloxanes b2) whose organic radicals are selected from saturated or unsaturated hydrocarbon radicals, i.e., which contain no aromatic groups. Additionally the organohydrogenpolysiloxanes b2) contain on average at least two SiH groups per molecule.

It is particularly preferred for both component b1) and component b2) to be present. In addition it is preferred for both component b1) and component b2) to be selected from at least one triorganosiloxy- or diorganohydrogensiloxy-endstopped polyorganohydrogensiloxane with more than 20 SiH units.

The organohydrogensiloxane b2) is preferably a linear, branched or cyclic polysiloxane which can have the following siloxy units:

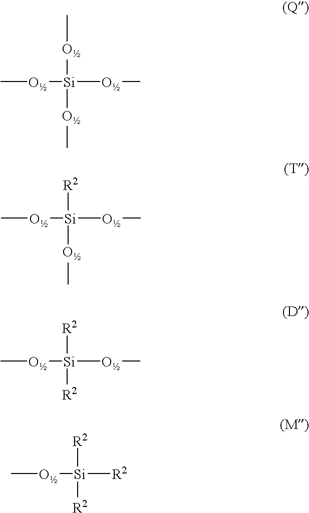

in which the substituents R² can be identical or different and are selected from the group consisting of
hydrogen,
a linear, branched or cyclic alkyl radical having up to 12 carbon atoms,
a linear, branched or cyclic alkenyl radical having up to 12 carbon atoms,
a linear, branched or cyclic alkoxy radical having up to 6 carbon atoms,
   or two substituents R¹ from different siloxy units together form a linear, branched or cyclic alkanediyl radical having 2 to 12 carbon atoms between two silicon atoms.

The organohydrogensiloxanes b2) are used optionally. They are employed in particular when it is necessary to optimize the rate of crosslinking, the rubber-mechanical properties, such as the tear propagation resistance, or aging properties (such as the hot air stability).

The SiH content of the optional component b2) is 0.2-16 mmol/g, preferably 4-16 mmol/g, based on polymethylhydrogendimethylsiloxanes, which is to be adapted correspondingly, equimolarly, in the presence of radicals R² having a different formula weight.

The number of siloxy units in the case of the organohydrogensiloxanes b2) is preferably 5 to 1000, but more preferably 10 to 500, more preferably still 10-200.

The siloxy units in b2) are preferably harmonized so as to result in liquid or siloxane-soluble hydrogensiloxanes having a viscosity of 0.5-50 000 mPa·s at 25° C. The siloxanes b2) also encompass the solids melting below 90° C. and having melt viscosities in the stated viscosity range, or solids which are soluble in typical solvents or siloxane polymers.

The preferred representatives are trimethyl- and/or hydrogendimethylsiloxy-endstopped polymethylhydrogendiorganosiloxanes.

The organohydrogensiloxanes b2) are prepared in a manner known per se, such as in U.S. Pat. No. 5,536,803, for example, the SiH content being adjusted through the choice of suitable weight proportions of the hydrogenorganosiloxy units to the organosiloxy units, and also monofunctional end groups such as trimethylsiloxy groups.

The preferred amount of the organohydrogensiloxanes b2) is 0 to 30 parts by weight per 100 parts by weight of component a).

The addition-crosslinking silicone rubber blend of the invention comprises c) at least one Pt, Ru and/or Rh catalyst for the crosslinking reaction or hydrosilylation. Platinum catalysts are preferred. Particularly preferred catalysts c) are preferably Pt(0) complexes, Pt(II) complexes or their salts, or Pt(IV) complexes or their salts with ligands such as alkenylsiloxanes, cycloalkyldienes, alkenes, halogens or pseudohalogen, carboxyl-, S-, N- or P-group-containing ligands as complexing agents in catalytic amounts of 1 to 1000 ppm, preferably 1-100 ppm, with particular preference 1-20 ppm, based on metal. Examples of Ru and/or Rh catalysts include the following: Rh or Ru complexes and salts, such as di-μ,μ′-dichloro-di(1,5-cyclo-octadiene)dirhodium. Rh compounds which can likewise be employed are the compounds described in J. Appl. Polym. Sci 30, 1837-1846 (1985).

The addition-crosslinking silicone rubber blend of the invention optionally comprises at least one inhibitor. Inhibitors for the purposes of the invention are all common compounds which have already been employed to date for retarding or inhibiting hydrosilylation. Examples of such preferred inhibitors are vinylmethylsiloxanes such as 1,3-divinyltetramethyldisiloxane, 1,3,5,7-tetravinyl-1,3,5,7-tetramethylcyclotetrasiloxane, alkynols such as 2-methylbutyn-2-ol or 1-ethynylcyclohexanol, U.S. Pat. No. 3,445,420, in amounts of 50 to 10 000 ppm, and also all other known S-, N- and/or P-containing inhibitors (DE-A-36 35 236) which make it possible to retard the hydrosilylation reaction brought about by pure Pt, Ru or Rh catalysts of component c).

The addition-crosslinking silicone rubber mixture of the invention further comprises at least one constituent selected from the group consisting of the following: alkoxysilanes and/or alkoxysiloxanes each having at least one epoxy group, acryl- and methacryloyloxyalkyltrialkoxysilanes, and also condensation products of the aforementioned compounds through reaction with water, alcohols, silanols and/or siloxanediols. The epoxy group is advantageously an epoxy group attached via an alkanediyl group to Si (epoxy-(CH2)x-Si). Preference is given to those which have not more than 5 C atoms in the alkoxy function and which typically carry 2, but more preferably 3, alkoxy groups per molecule. These include epoxysiloxanes and epoxysiloxanes as described in EP 691 364.

The alkoxysilanes d) also include glycidyloxypropyltrialkoxysilanes and also dialkoxysilanes or 2-(3,4-epoxycyclohexyl)ethyltrialkoxysilane, epoxylimonyltrialkoxysilanes, epoxidized norbornenylethyltrialkoxysilanes or ethylidene-norbornyltrialkoxysilanes, and also other C₃- to C₁₄-epoxidized alkenyl- and/or alkenylaryltrialkoxysilanes, epoxidized trisalkoxysilylpropylallyl cyanurates and isocyanurates, and also in each case their dialkoxy derivatives, acryl- and/or methacryloyloxypropyltrialkoxysilanes, and also their condensation products by reaction with water, alcohols or silanols and/or siloxanediols.

Preference is given to mono(epoxyorgano)trialkoxysilanes, such as glycidyloxypropyltrimethoxysilane, for example, 2-(3,4-epoxycyclohexyl)ethyltrialkoxysilane, or methacryloyloxypropyltrimethoxysilane and/or the siloxanes thereof, particular preference to mixtures of glycidyloxypropyltrimethoxysilane and methacryloyloxypropyltrimethoxysilane in amounts of 0.01 to 10 parts per 100 parts of component a), or about 0.002% to 9.1% by weight based on the total amount of the addition-crosslinking silicone rubber blend.

As described for component b1), it is also possible to use reaction products, produced by hydrosilylation, of d) with a) and b), or reaction products, produced by condensation, of d) with b).

The addition-crosslinking silicone rubber blend of the invention further optionally comprises one or more fillers (f) with or without surface modification. These fillers include, for example, the following: all finely divided fillers, i.e., those with particles smaller than 100 μm, which do not disrupt the Pt catalyzed crosslinking reaction, thereby allowing the production of elastomeric coatings, moldings or extrudates.

They may be mineral fillers such as silicates, carbonates, nitrides, oxides, carbon blacks or silicas. The fillers are preferably of the kind which reinforce the rubber-mechanical properties, such as fumed or precipitated silica having BET surface areas of between 50 and 400 m²/g, for example, and may also have been surface-treated, in amounts of 0 to 300 parts by weight, preferably 10 to 50 parts, per 100 parts by weight of component a).

Fillers having BET surface areas above 50 m²/g allow the production of silicone elastomers having improved rubber-mechanical properties. The rubber-mechanical strength and the transparency increase in the case, for example, of fumed silicas, such as Aerosil, HDK, Cab-O-Sil, with their surface area.

It is further possible, additionally or alternatively, to make use of what are called extender fillers, such as finely ground quartz, diatomaceous earths, finely ground cristabolites, mica, aluminum oxides, Ti, Fe, and Zn oxides, chalks or carbon blacks, for example, having BET surface areas of 1-50 m²/g.

The term “filler f)” is taken to refer to the fillers including their surface-attached hydrophobicizers and/or dispersants and/or process aids, which influence the interaction of the filler with the polymer, such as the thickening action, for example. The surface treatment of the fillers is preferably a hydrophobicization with silanes or siloxanes. This can be done, for example, in situ through the addition of silazanes, such as hexamethylsilazane and/or divinyltetramethyldisilazane, and water; in situ hydrophobicization is preferred. It may also take place with other common filler treatment agents, such as vinylalkoxysilanes, an example being vinyltrimethoxy-silane, organosiloxanediols having chain lengths of 2-50, in order to provide reactive sites for the crosslinking reaction, and also with fatty acid derivatives or fatty alcohol derivatives.

The addition-crosslinking silicone rubber blend of the invention further optionally comprises at least one auxiliary g), such as phenylsiloxane oils, for example, which provide self-lubricating vulcanizates, examples being copolymers composed of dimethylsiloxy and diphenylsiloxy or methylphenylsiloxy groups and also polysiloxanes with methylphenylsiloxy groups, having a viscosity of preferably 0.1-10 Pa·s (25° C.) or colorants or color pigments in the form of color pastes, additional mold release agents such as fatty acid derivatives or fatty alcohol derivatives, extrusion aids, such as boric acid or PTFE pastes, biocides such as fungicides, for example, and hot air stabilizers, such as Fe, Ti, Ce, Ni, and Co compounds. The amount of the auxiliaries is preferably 0 to 15 parts by weight per 100 parts by weight of component a) and is preferably below 13% by weight, based on the total amount of the rubber blend.

The invention further provides organohydrogenpolysiloxanes characterized in that they have on average at least 20 hydrogensiloxy units in the molecule, in that they include Si-bonded monovalent organic radicals containing aromatic groups, and the amount of the monovalent organic radicals containing aromatic groups is less than 12 mol %. These organohydrogenpolysiloxanes are preferably subject to the ranges of preference specified above for component b1).

The addition-crosslinking silicone rubber blend of the invention preferably does not comprise any separate, Si-containing biphenyl adhesion promoter components. This includes those compounds in which two phenyl groups are joined via a divalent radical, such as unsubstituted or substituted alkylene, SO₂—, —SO—, —CO—, —O— or —O—Si(CH₃)₂—O—. In particular there is preferably no biphenyl adhesion promoter according to the definition of component (C) of EP 1375622 present, the relevant content of that patent being incorporated fully by reference.

The invention further provides a method of producing the addition-crosslinking silicone rubber blend, which comprises mixing components a) to d) and optionally components e) to g).

This mixing is accomplished preferably using mixers suitable for high-viscosity pastes, such as compounders, dissolvers or planetary mixers, for example, under an inert gas atmosphere.

In one preferred embodiment the reinforcing fillers, i.e., those having BET surface areas above 50 m²/g, are mixed in such a way that they are hydrophobicized in situ during the mixing operation.

In this case it is preferred to stir the organopolysiloxanes a), fillers, and the hydro-phobicizing agent, preferably hexamethyldisilazane and/or divinyltetramethyldisilazane, with water in the presence of silicas of component f), preferably at temperatures of 90 to 100° C., for at least 20 minutes in a mixer suitable for high-viscosity materials, such as a compounder, dissolver or planetary mixer, for example, and then to free the mixture from excess hydrophobicizing agents and water at 150 to 160° C., initially by evaporation under atmospheric pressure and subsequently under a reduced pressure of 100 to 20 mbar. The further components are then mixed in advantageously over 10 to 30 minutes.

One preferred embodiment of the method of producing the addition-crosslinking silicone rubber blend starts by preparing at least one partial mixture which includes more than one, but not all, of components a) to g).

The aim of this subdivision into partial mixtures is improved handling of the reactive mixture composed of the constituents a) to d) and also, where appropriate, e) to g). Constituents b1) and b2) in particular ought for the purpose of storage to be kept separately, preferably, from the catalyst c). The constituent d) and the inhibitor e) can be held more or less advantageously in any of the components, provided that the interreacting components a), b1)/b2), and c) are not present alongside one another at the same time.

In one preferred embodiment of the method of the invention of producing the addition-crosslinking silicone rubber blend to start with a first partial mixture is prepared by combining
at least one organopolysiloxane a),
if desired, at least one filler f),
if desired, at least one auxiliary g),
at least one catalyst c), and
if desired, at least one alkoxysilane and/or alkoxysiloxane d),
a second partial mixture is prepared by combining
   if desired, an organopolysiloxane a),
   at least one organohydrogensiloxane b1),
   if desired, at least one organohydrogenpolysiloxane b2),
   if desired, at least one filler f),
   if desired, at least one alkoxysilane and/or alkoxysiloxane d),
   if desired, at least one inhibitor e), and
   if desired, at least one auxiliary g),
and the two partial mixtures are subsequently mixed.

In another preferred embodiment of the method of the invention of producing the addition-crosslinking silicone rubber blend, in which component b2) is used, to start with a first partial mixture is prepared by combining
at least one organopolysiloxane a),
if desired, at least one filler f),
if desired, at least one auxiliary g),
at least one catalyst c), and
if desired, at least one alkoxysilane and/or alkoxysiloxane d), provided they are not present in the second or third partial mixture,
a second partial mixture is prepared by combining
   at least one organohydrogensiloxane b2),
   if desired, an organopolysiloxane a),
   if desired, at least one filler f),
   if desired, at least one alkoxysilane and/or alkoxysiloxane d), where not present in the first or third partial mixture
   if desired, at least one inhibitor e), and
   if desired, at least one auxiliary g),
a third partial mixture is prepared by combining
   at least one organohydrogensiloxane b1) containing an aromatic group and/or
   at least one alkoxysilane and/or alkoxysiloxane d),
   if desired, at least one organopolysiloxane a),
   if desired, at least one filler f), and
   if desired, at least one auxiliary g)
and the three partial mixtures are subsequently mixed.

The term “partial mixture” or “reactive component” also includes the case in which the partial mixture contains only one component.

The invention further provides addition-crosslinked silicone rubber blends obtained by crosslinking or vulcanizing the addition-crosslinking silicone rubber blends of the invention. Crosslinking or vulcanizing takes place, depending on the reactivity of the addition-crosslinking silicone rubber blends, within a temperature range from 0 to 300° C.

Crosslinking may take place where appropriate under atmospheric pressure, reduced pressure down to 20 mbar, or superatmospheric pressure in the presence of ambient air. Superatmospheric pressure in the presence of ambient air includes injection molding and crosslinking on a substrate surface under injection conditions, i.e., up to 300 bar relative to the unit area of the molding.

The addition-crosslinked silicone rubber blends are generally elastomeric moldings.

The invention further provides a method of producing composite moldings, characterized in that at least one of the addition-crosslinking silicone rubber blends of the invention is crosslinked on a mineral, metallic, thermoset and/or thermoplastic substrate.

A preferred substrate is a thermoplastic substrate, and with particular preference the substrate is of polybutylene terephthalate, polyamide or polyphenylene sulfide.

In one preferred embodiment of the method of the invention of producing the composite moldings, the addition-crosslinking silicone rubber blend of the invention is applied to the surface of a pre-produced thermoplastic molding, where appropriate with spreading, casting, calendering, knife coating, and rolling, preferably under atmospheric pressure, and then is crosslinked—and adhered in the process—at temperatures from 0 to 300° C., preferably 50 to 250° C.

With particular preference the preferably thermoplastic molding is produced immediately prior to the application of the addition-crosslinking silicone rubber blend.

In another preferred embodiment of the method of the invention of producing the composite moldings, the addition-crosslinking silicone rubber blend of the invention is crosslinked or vulcanized, and in the process adhered, at temperatures from 50 to 300° C. on the surface of a thermoplastic molding which preferably has been injection-molded immediately beforehand in an injection mold.

The aforementioned methods of producing the composite moldings generally involve applying the addition-crosslinking silicone rubber blend to the substrate by injection into the vulcanizing chamber in which the surface of the substrate is located. In this case the addition-crosslinking silicone rubber blend is preferably produced immediately beforehand by mixing of components a) to g). With particular preference the above-described reactive partial mixtures are prepared beforehand, and are then mixed. It is also possible for the reactive partial mixtures to be injected directly onto the target substrate, and then crosslinked.

The substrates which can be coated with the crosslinked silicone rubber blends of the invention further include, for example, the following: glass, unpretreated or pretreated metal or, preferably, unpretreated or pretreated plastic. Examples of preferred thermoplastic includes polyethylene terephthalate, polybutylene terephthalate, all-aromatic polyesters, liquid-crystalline polyesters, polycyclo-hexylene terephthalate, polytrimethylene terephthalate, aliphatic polyamides, polyphthalamide, partially aromatic polyamides, polyphenyl amide, polyamideimides, polyetherimides, polyphenylene oxide, polysulfone, polyether sulfone, aromatic polyether ketones, PMMA, polycarbonate, ABS polymers, fluoropolymers, syndiotactic polystyrene, ethylene-carbon monoxide copolymers, polyphenylene sulfone, polyarylene sulfide, and polyphenylene sulfoxide. Thermoset plastics include, for example, the following: melamine resins, urethane resins, epoxy resins, phenylene oxide resins or phenolic resins.

In the course of the crosslinking or vulcanizing operation these substrate surfaces are adhered with at least one addition-crosslinkable or crosslinking silicone rubber blend of the invention.

The silicone rubber blend, divided into two to three reactive partial mixtures, is brought together prior to vulcanization, by mixing in an automatic injection-molding unit or in an upstream mixing head and, if desired, downstream static mixer, the mixtures are mixed, and the resulting mixture is then crosslinked at 0-300° C. and adhered. It is preferred, after mixing, to inject the components into a mold at an elevated temperature of 50-250° C. The cavity of this mold that accommodates the silicone rubber blend need not be coated or treated with mold release agents in order to reduce the level of adhesion to the mold surface to a level low enough for demolding. Information on the design of the molds, which are preferably charged in succession with a thermoset or thermoplastic material and with an elastomeric material, are found in Schwarz; Ebeling; Furth: Kunststoffverabeitung, Vogel-Verlag, ISBN: 3-8023-1803-X

Walter Michaeli: Einführung in die Kunststoffverarbeitung, Hanser-Verlag, ISBN 3-446-15635-6.

In order to be able to run the molds and keep them closed, it is preferred to select automatic injection-molding units with locking forces of greater than 3000 N/cm² of molding surface.

All customary automatic injection-molding units can be employed for the methods of the invention. The technical selection is determined by the viscosity of the silicone rubber blend and also the molding dimensions.

The proportions of the reactive partial mixtures employed correspond to those which result after the inventively described silicone rubber blends have been mixed. They are determined by the desired Si-alkenyl to SiH ratio and also by the required amounts of adhesion-promoting constituents of components b1) and, where appropriate, b2).

The invention additionally provides for the use of the addition-crosslinking silicone rubber blend of the invention for producing composite moldings such as, for example, sealing and/or damping mounting elements, handles, keyboards, switches, showerheads, plugs with elastomeric seals, lamp sockets or other fixings which have both a thermoplastic part and a silicone rubber part.

### WORKING EXAMPLES

### Example 1

### Comparative Test

### Preparation of a Base Mixture BM 1:

In a dissolver, 9.1 parts of dimethylvinylsiloxy-endstopped polydimethylsiloxane a1) having a viscosity of 10 Pa·s (25° C.) and 16.5 parts of dimethylvinylsiloxy-endstopped polydimethylsiloxane a2) having a viscosity of 65 Pa·s (25° C.) were mixed with 2.9 parts of hexamethyldisilazane and 1.0 part of water, and this mixture was then mixed with 11.1 parts of fumed silica f) having a BET surface area of 300 m²/g (Aerosil 300® Degussa), heated to about 100° C., stirred for about 1 h, and thereafter freed at 150 to 160° C. from water and excess residues of the hydrophobicizing agent (at the end under reduced pressure at p=20 mbar), and subsequently diluted with 6.2 parts of a1). This gives a base mixture BM 1.

After cooling, about 200 parts of the base mixture BM 1 were mixed with 6 parts of the dimethylvinylsiloxy-endstopped polydimethylsiloxane a1) having a viscosity of 10 Pa·s (25° C.), 0.6 part of a dimethylvinylsiloxy-endstopped polydimethylsiloxane a3) with methylvinylsiloxy groups, having a vinyl content of 2 mmol/g and a viscosity of 0.2 Pa·s, 1.5 parts of glycidyloxypropyltrimethoxysilane, 1.8 parts of methacryloyloxypropyltrimethoxysilane and also 0.1 part of ethynylcyclohexanol as inhibitor and 0.0145 parts of a Pt complex compound c) with alkenylsiloxane ligands in tetramethyltetravinylcyclotetrasiloxane (Pt content: 15% by weight) and additionally with 1.1 parts of a trimethylsilyl-endstopped methylhydrogensiloxane b2) having an average SiH content of 15 mmol/g and an average MeHSiO group content of 30 per molecule of component b2), 2.0 parts of a trimethylsilyl-endstopped diphenylmethylhydrogendimethylpolysiloxane b1) M₂D₇D^{H}₆D^{phe2}_{0.9} having an average SiH content of 4.9 mmol/g. Component b1) has originated from an anionic equilibration.

The reactive blend is in each case cured or vulcanized into a mold having a mold cavity, which in each case contains an inserted thermoplastic part, as specified in Table 1, under the conditions given. For all of the elastomer/thermoplastic composite parts tested, the adhesion result obtained is good.

### Example 2

### Inventive

After cooling, about 200 parts of the base mixture BM 1 were mixed with 6 parts of the dimethylvinylsiloxy-endstopped polydimethylsiloxane a1) having a viscosity of 10 Pa·s (25° C.), 0.6 part of a dimethylvinylsiloxy-endstopped polydimethylsiloxane a3) with methylvinylsiloxy groups, having a vinyl content of 2 mmol/g and a viscosity of 0.2 Pa·s (25° C.), 1.5 parts of glycidyloxypropyltrimethoxysilane, 1.8 parts of methacryloyloxypropyltrimethoxysilane and also 0.1 part of ethynylcyclohexanol as inhibitor and 0.0145 part of a Pt complex compound c) with alkenylsiloxane ligands in tetramethyltetravinylcyclotetrasiloxane (Pt content: 15% by weight) and additionally with 0.34 part of a trimethylsilyl-endstopped methylhydrogensiloxane b2) having an average SiH content of 15 mmol/g and an average MeHSiO group content of 30 per molecule of component b2), 2.0 parts of a trimethylsilyl-endstopped diphenylmethylhydrogendimethylpolysiloxane b1) M₂D₂D^{H}₂₄D^{phe2}₂ having an average SiH content of 10.8 mmol/g as component b1). Component b1) has originated from an anionic equilibration.

The reactive blend is in each case cured or vulcanized into a mold having a mold cavity, which in each case contains an inserted thermoplastic part, as specified in Table 1, under the conditions given. For all of the elastomer/thermoplastic composite parts tested, the adhesion results obtained are outstanding, and the majority of them are situated at a higher level than those of comparative example 1.

TABLE 1

| | Example 1 comparative | Example 2 inventive |
|---|---|---|
| Substrate | [N/mm] | [N/mm] |
| PA 6.6 | 2.6 | 4.0 |
| PA 6 | 3.5 | 2.9 |
| PBT | 2.5 | 3.5 |
| PPS | 2.0 | 3.2 |
| Total | 10.6 | 13.6 |

### Production and Evaluation of the Composite Parts:

The composite parts were produced in a laboratory pressing mold, following insertion of the thermoplastic moldings with a thickness of approximately 3 mm, by vulcanizing the respective silicone rubber blend at 175° C. for 10 minutes on the surface of the respective thermoplastic molding.

The molds used in the examples to produce the composite moldings were steel molds with a surface coating of Teflon®. The adhesion of the cured silicone rubber blends to various thermoplastic substrates was tested in a method based on DIN 53 289 (roller peel test) with at least 2 specimens in each case, and with a pulling speed of 100 mm/min, 24 hours after production, without the composite part specimens being given an additional heat treatment. The results of the roller peel tests are summarized in Table 1.

1. An addition-crosslinking silicone rubber blend comprising:
a) at least one linear or branched organopolysiloxane having at least two alkenyl groups, with a viscosity of 0.01 to 30 000 Pa·s (25° C.),
b1) at least one organohydrogensiloxane having in each case on average at least 20 SiH units per molecule and having at least one organic radical containing at least one constituent selected from aromatic groups, halogen atoms, pseudohalogen groups, polyether groups, aminoalkyl groups, and ammonioalkyl groups,
b2) if desired, one or more organohydrogenpolysiloxanes which have on average at least two SiH groups per molecule and in which the organic radicals are selected from the following: saturated and unsaturated aliphatic hydrocarbon radicals,
c) at least one hydrosilylation catalyst,
d) at least one constituent selected from the group consisting of the following: alkoxysilanes and/or alkoxysiloxanes each having at least one epoxy group, acryl- and methacryloyloxyalkyltrialkoxysilanes, and condensation products of the aforementioned compounds through reaction with water, alcohols, silanols and/or siloxanediols,
e) if desired, at least one inhibitor,
f) if desired, at least one filler with or without surface modification,
g) if desired, at least one auxiliary.

2. The addition-crosslinking silicone rubber blend of claim 1, characterized in that the organopolysiloxane a) is a linear or branched polysiloxane which can have the following siloxy units: 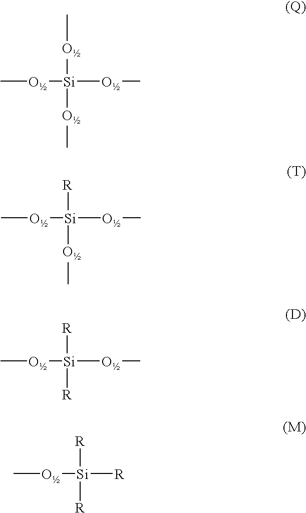
in which the substituents R can be identical or different and are selected from the group consisting of
a linear, branched or cyclic alkyl radical having up to 12 carbon atoms, which if desired can be substituted by at least one substituent selected from the group consisting of phenyl and halogen,
a linear, branched or cyclic alkenyl radical having up to 12 carbon atoms,
a phenyl radical,
hydroxyl, and
a linear, branched or cyclic alkoxy radical having up to 6 carbon atoms, or two substituents R from different siloxy units together form a linear, branched or cyclic alkanediyl radical having 2 to 12 carbon atoms between two silicon atoms, with the proviso that at least two substituents R per molecule represent the stated alkenyl radical, which can be identical or different.

3. The addition-crosslinking silicone rubber blend of claim 1, wherein component b1) are selected from linear, branched or cyclic polysiloxanes which can have the following siloxy units: 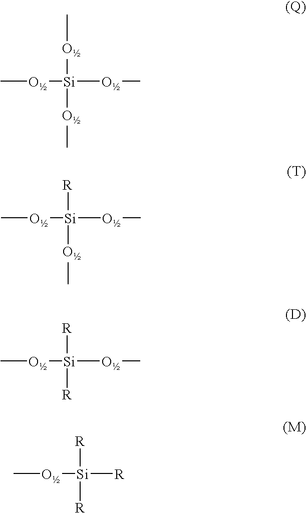
in which R¹ can be identical or different and is selected from the group consisting of
hydrogen
a linear, branched or cyclic alkyl radical having up to 12 carbon atoms, which if desired can be substituted by at least one substituent selected from the group consisting of phenyl and halogen,
a linear, branched or cyclic alkenyl radical having up to 12 carbon atoms,
an aromatic group, and
a linear, branched or cyclic alkoxy radical having up to 6 carbon atoms, or two groups R¹ from different siloxy units together form a linear, branched or cyclic alkanediyl radical having 2 to 12 carbon atoms between two silicon atoms.

4. The addition-crosslinking silicone rubber blend of claim 1, wherein the organohydrogensiloxane b1) has on average in each case at least 23 SiH units per molecule.

5. The addition-crosslinking silicone rubber blend of claim 1, wherein the Si—H content of the organohydroxysiloxane b1), defined as the proportion of the silicon-bonded H atoms relative to the sum of the silicon-bonded H atoms and the silicon-bonded organic groups, is more than 36 mol %.

6. The addition-crosslinking silicone rubber blend of claim 1, wherein the organohydrogensiloxane b1) has at least one unsubstituted or substituted aromatic group.

7. The addition-crosslinking silicone rubber blend of claim 1, wherein the organohydrogensiloxane b1) is a linear triorganosiloxy- and/or diorganohydrogensiloxy-endstopped organohydrogensiloxane, wherein the triorganosiloxy end groups are selected from the group consisting of trimethylsiloxy, triphenylsiloxy, diphenylmethylsiloxy, phenyldimethylsiloxy, phenylethyldimethylsiloxy, and phenylpropyldimethoxysiloxy, the diorganohydrogensiloxy end group is preferably a dimethylhydrogensiloxy group, and that has on average 20 to 1000 methylhydrogensiloxy units, on average less than 500 dimethylsiloxy groups, on average less than 360 (methyl)(phenyl)siloxy units, and on average less than 180 diphenylsiloxy units.

8. The addition-crosslinking silicone rubber blend of claim 1, characterized in that the alkoxysilanes of component d) are selected from glycidyloxypropyltrialkoxysilane, 2-(3,4-epoxycyclohexyl)-ethyltrialkoxysilane, and methacryloyloxypropyltrialkoxysilane.

9. A method of producing the addition-crosslinking silicone rubber blend of claim 1, characterized in that it comprises mixing components a) to d) and optionally components e) to g).

10. The method of claim 9, characterized in that it includes the production of at least one partial mixture which comprises more than one, but not all, of components a) to g).

11. The method of claim 9, characterized in that a first partial mixture is prepared by combining
at least one organopolysiloxane a),
if desired, at least one filler f),
if desired, at least one auxiliary g),
at least one catalyst c), and
if desired, at least one alkoxysilane and/or alkoxysiloxane d),
a second partial mixture is prepared by combining
if desired, an organopolysiloxane a),
at least one organohydrogensiloxane b1),
if desired, at least one organohydrogenpolysiloxane b2),
if desired, at least one filler f),
if desired, at least one alkoxysilane and/or alkoxysiloxane d),
if desired, at least one inhibitor e), and
if desired, at least one auxiliary g),
and the two partial mixtures are subsequently mixed.

12. An addition-crosslinked silicone rubber blend obtained by crosslinking the compositions of claim 1.

13. A method of producing composite moldings, characterized in that at least one addition-crosslinking silicone rubber blend of claim 1 is crosslinked on a substrate.

14. The method of claim 13, wherein the substrate is selected from mineral, metallic, thermoset and/or thermoplastic substrates.

15. The method of claim 13, characterized in that the silicone rubber blend is applied to the surface of a pre-produced thermoset or thermoplastic molding, where appropriate with spreading, casting, calendering, knife coating, and rolling, and then is crosslinked at temperatures of 0 to 300° C., in the course of which it is adhered.

16. The method of claim 13, characterized in that the silicone rubber blend is vulcanized at temperatures of 50-300° C. on the surface of a thermoset or thermoplastic molding which has been injection-molded beforehand in an injection mold, and in the course of this vulcanization is adhered.

17. The method of claim 13, characterized in that the thermoplastic material is selected from polybutylene terephthalate, polyamide or polyphenylene sulfide.

18. (canceled)

18. (canceled)

19. A composite molding comprising a mineral, metallic, thermoset and/or thermoplastic substrate and an addition-crosslinked silicone rubber blend of claim 12.

20. The composite molding of claim 19, which is a sealing and/or damping mounting element, handle, keyboard, plug with elastomeric seals, switch, showerhead, lamp socket or other fixing.

21. An organohydrogenpolysiloxane b1) characterized in that it has on average at least 20 hydrogensiloxy units in the molecule, in that it includes Si-bonded monovalent organic radicals which contain aromatic groups, and the amount of the monovalent organic radicals which contain aromatic groups is less than 12 mol %.

22. The method of 13, wherein the addition-crosslinking silicone rubber blend is produced by mixing partial mixtures as described in claim 10.

23. A component set consisting of at least two storage-stable components which when combined produce the addition-crosslinking composition of claim 1.
